(19) United States
(12) Patent Application Publication
(10) Pub. No.: US 2017/0366361 A1
(43) Pub. Date: Dec. 21, 2017

(54) Transmit Power Management In A Wire-Line Communication System

(71) Applicant: QUALCOMM Incorporated, San Diego, CA (US)

(72) Inventors: Hassan Afkhami, San Jose, CA (US); Purva Rajoktia, Orlando, FL (US)

(21) Appl. No.: 15/188,551

(22) Filed: Jun. 21, 2016

(51) Int. Cl. H04L 12/10; H04B 17/309; H04B 3/52; H04B 3/54

(52) U.S. Cl. CPC H04L 12/10; H04B 3/54; H04B 17/309; H04B 3/52

(57) ABSTRACT

Embodiments include systems and methods for performing transmit power management in a wire-line communication system. A processor of a wire-line communication system may determine one or more signal characteristics of a radio frequency (RF) signal received by the wire-line communication system. The processor may characterize the received signal based on the one or more signal characteristics. The processor may determine whether the received RF signal is a valid signal based on the characterization of the received signal. The processor may determine a transmit power for a signal from the wire-line communication system based on the characterization of the received RF signal when the received RF signal is a valid signal.

### BACKGROUND

Wire-line communication systems use an unshielded conductor to carry a communication signal. For example, power-line communication (PLC) systems use electrical wiring for alternating current (AC) electric power transmission to also communicate data, and digital subscriber line (DSL) systems use the twisted-pair telephone wiring for digital communications.

Regulatory agencies impose restrictions on radiated energy levels for wire-line communication systems to avoid interference with wireless communication services, particularly licensed wireless spectrum users. For example, certain standards, such as those issued by the European Committee for Electrotechnical Standardization (CENELEC), require PLC systems to avoid generating signals that interfere with detected radio frequency (RF) signals. PLC systems are required to reduce PLC transmission power in a discrete frequency range around RF signals. The power reduction is either static or dynamic When power reduction is dynamic, the PLC system relies on some methods of detecting the presence of RF signals. Dynamically reducing wire-line transmit power in a discrete frequency range is also called “notching” or “spectrum notching.” The wire-line system may use available un-notched frequency bandwidth for wire-line data communications.

Currently, wire-line systems rely on the signal level of a received RF signal for signal detection (that is, current wire-line signal detection systems are “energy-based”). If the wire-line system receives a signal with a signal level that exceeds a threshold signal level, the wire-line system performs notching around the frequency of the received signal.

However, such signal detection mechanisms are vulnerable to false signal detection (i.e., false positives), which cause the wire-line system to perform spectrum notching unnecessarily, thus reducing the bandwidth available for wire-line data transmission.

### SUMMARY

Various embodiments and implementations include methods implemented in a wire-line signal analyzer for transmit power management in a wire-line communication system. Various embodiments and implementations may include determining one or more signal characteristics of a radio frequency (RF) signal received by the wire-line communication system, characterizing the received RF signal based on the one or more signal characteristics, determining whether the received RF signal is a valid signal based on the characterization of the received signal, and determining a transmit power for a signal from the wire-line communication system based on the characterization of the received RF signal when the received RF signal is a valid signal.

Some implementations may further include ignoring the received RF signal in response to determining that the received RF signal is not a valid signal. Some implementations may further include determining whether to reduce the transmit power for the signal from the wire-line communication system based on the characterization of the received RF signal in response to determining that the received RF signal is not a valid signal. Such embodiments may further include determining the transmit power for a signal from the wire-line communication system based on the characterization of the received RF signal in response to determining to reduce the transmit power based on the characterization of the received RF signal. Some embodiments may further include ignoring the received RF signal in response to determining not to reduce the transmit power based on the characterization of the received RF signal. Some implementations may further include determining whether the received RF signal is a known noise signal, and ignoring the received RF signal in response to determining that the received RF signal is a known noise signal.

In some implementations, the one or more signal characteristics may be selected from the group consisting of a signal pattern, a signal bandwidth, a date and time of reception, a signal duration, a signal modulation, a signal preamble, and a channel spacing. In some implementations, characterizing the received RF signal based on the one or more signal characteristics may include determining whether a signal pattern matches a known signal pattern. In some implementations, characterizing the received RF signal based on the one or more signal characteristics may include determining whether bandwidth of the received RF signal matches a known signal bandwidth. In some implementations, characterizing the received RF signal based on the one or more signal characteristics may include determining whether bandwidth of the received RF signal bandwidth exceeds a known signal bandwidths.

In some implementations, characterizing the received RF signal based on the one or more signal characteristics may include determining whether a date and time of reception of the received RF signal matches a signal broadcast schedule. In some implementations, characterizing the received RF signal based on the one or more signal characteristics may include determining whether a duration of the received RF signal exceeds a threshold duration. In some implementations, characterizing the received RF signal based on the one or more signal characteristics may include determining whether a preamble is detected in the received RF signal. In some implementations, characterizing the received RF signal based on the one or more signal characteristics may include determining whether signal modulation is detected in the received RF signal.

In some implementations, characterizing the received RF signal based on the one or more signal characteristics may include determining whether a channel spacing of the received RF signal matches one or more known channel spacings. In some implementations, characterizing the received RF signal based on the one or more signal characteristics may include determining a characterization score based on the one or more signal characteristics. In some implementations, characterizing the received RF signal based on the one or more signal characteristics may include comparing the one or more determined signal characteristics to characteristics of one or more known noise signals. In some implementations, characterizing the received RF signal based on the one or more signal characteristics may include comparing the one or more determined signal characteristics to characteristics of one or more known valid signals. Some implementations may further include adding the received RF signal and the one or more signal characteristics to a memory of the wire-line communication system.

Further embodiments include a multimode communication device including a processor configured with processor-executable instructions to perform operations of the embodiment methods summarized above. Further embodiments include a non-transitory processor-readable storage medium having stored thereon processor-executable software instructions configured to cause a processor to perform operations of the embodiment methods summarized above. Further embodiments include a multimode communication device that includes means for performing functions of the embodiment methods summarized above.

### BRIEF DESCRIPTION OF THE DRAWINGS

The accompanying drawings, which are incorporated herein and constitute part of this specification, illustrate various embodiments, and together with the general description given above and the detailed description given below, serve to explain the features of various embodiments.

FIG. 1 is a system block diagram of a communication system in which the various embodiments may be used.

FIG. 2 is a component block diagram illustrating a wire-line signal analyzer suitable for use with various embodiments.

FIG. 3A is a process flow diagram illustrating a method for transmit power management according to various embodiments.

FIG. 3B is a process flow diagram illustrating a method for transmit power management according to various embodiments.

FIG. 4 is a process flow diagram illustrating a method for transmit power management according to various embodiments.

FIG. 5 is a process flow diagram illustrating a method for transmit power management according to various embodiments.

FIG. 6 is a process flow diagram illustrating a method for transmit power management according to various embodiments.

FIG. 7 is a process flow diagram illustrating a method for transmit power management according to various embodiments.

### DETAILED DESCRIPTION

Various embodiments and implementations will be described in detail with reference to the accompanying drawings. Wherever possible, the same reference numbers will be used throughout the drawings to refer to the same or like parts. References made to particular examples and implementations are for illustrative purposes, and are not intended to limit the scope of various embodiments or the claims.

Various embodiments provide methods for transmit power management in a wire-line communication system based on characterizing RF signals received by the wire-line system. The transmit power management performed by the wire-line communication system may mitigate interference with the received RF signal that may be caused by signals transmitted by the wire-line communication system.

The term “component” and “unit” are intended to include a computer-related part, functionality or entity, such as, but not limited to, hardware, firmware, a combination of hardware and software, software, or software in execution, that is configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

Some wire-line communication systems use an “energy-based” signal detection method that relies on the signal strength of a received RF signal. If such wire-line communication system detects a signal level that exceeds a threshold signal level, the wire-line communication system performs transmit level notching around the frequency or frequencies of the received signal, and the wire-line communication system reduces its transmission power in a frequency range(s) that overlaps the frequency of the detected signal. However, such signal detection mechanisms are vulnerable to falsely detecting an RF signal and reducing transmission power unnecessarily, thus reducing the bandwidth available for wire-line communication data transmission.

In various embodiments and implementations, a wire-line communication system may characterize a received RF signal based on one more signal characteristics, and may determine whether to reduce transmit power in one or more frequencies based on the characterization of the received RF signal. In some implementations, the wire-line communication system may determine whether the received signal is a valid signal based on the characterization of the received RF signal. In such implementations, the wire-line communication system may determine a transmit power for signal from the wire-line communication system based on the characterization of the received RF signal when the received RF signal is a valid signal. In various embodiments, a “valid” signal is a received RF signal for which the wire-line communication system will reduce transmit power in a frequency range of the received RF signal.

In some implementations, the wire-line communication system may determine whether the received RF signal is not a valid signal. In some implementations, the wire-line communication system may determine whether the received RF signals a known noise signal. In response to determining that the received RF signal is not a valid signal and/or that the received RF signal is a known noise signal, the wire-line communication system may not reduce transmit power based on the received RF signal, even though transmit power reduction might be reduced using a an “energy-based” decision criterion. For example, the wire-line communication system may ignore a received RF signal (e.g., the wire-line communication system may not perform spectrum notching based on the received RF signal) that has an energy level exceeding an “energy-based” decision criterion for transmit power reductions in response to determining that the received RF signal is a known noise signal.

In various implementations, the wire-line communication system may determine one or more signal characteristics of the received RF signal to characterize the received RF signal. Such signal characteristics may include a signal pattern, a signal bandwidth, a date and/or time of reception of the received RF signal, a duration of the received RF, a modulation within the received RF, a preamble within the received RF, and channel spacing of one or more channels in the received RF signal.

In some implementations, the wire-line communication system may weigh or consider one or more of the signal characteristics to characterize the received RF signal. For example, the wire-line communication system may determine whether a pattern of the received RF signal matches a known signal pattern. The wire-line communication system may also determine whether a bandwidth of the received RF signal matches a known signal bandwidth. The wire-line communication system may determine whether a bandwidth of the received RF signal exceeds a known signal bandwidth. The wire-line communication system may also determine whether a date and/or time of reception of the received RF signal matches a known signal broadcast schedule. The wire-line communication system may determine whether a duration of the received RF signal exceeds a threshold duration. The wire-line communication system may also determine whether a signal modulation is detected in the received RF signal. The wire-line communication system may also determine whether a preamble is detected in the received RF signal. The wire-line communication system may also determine whether a channel spacing of the received RF signal matches a known channel spacing. Various implementations may characterize the received RF signal using one or more of such determinations, or other similar determinations based on signal characteristics of the received RF signal.

Based on the characterization of the received RF signal and/or one or more of the signal characteristics, the wire-line communication system may determine a transmit power for a signal from the wire-line communication system. In some implementations, the wire-line communication system may use the characterization of the received RF signal and/or the one or more signal characteristics to determine the appropriate transmit power. The appropriate transmit power may be determined to narrowly tailor the reduction in transmit power to the received RF signal. The wire-line communication system may apply the determined transmit power to a signal (e.g., a data signal) that the wire-line communication system transmits.

In various implementations, the wire-line communication system may store the received RF signal and one or more determined signal characteristics in memory of the wire-line communication system (e.g., by adding a data entry to a database or another similar data structure stored in memory). The wire-line communication system may use information about the received RF signal and/or determine signal characteristics to more rapidly and accurately identify an RF signal received in the future. The wire-line communication system may use the identity of the received RF signal to determine that the received RF signal is a valid signal for which the wire-line communication system will perform transmit power management to minimize/avoid interference. Alternatively, the wire-line communication system may use the identity of the received RF signal to determine that the received RF signal is a noise signal or an invalid signal that does not require the wire-line communication system to perform transmit power management because interference is not of concern.

The various embodiments and implementations enable a wire-line communication system to make rapid, accurate decisions about whether to reduce transmit power in one or more frequencies of a detected RF signal, thereby preserving wire-line bandwidth for communications while avoiding causing interference with wireless communication systems of another wireless service. The various embodiments and implementations may also increase overall wire-line communication capacity.

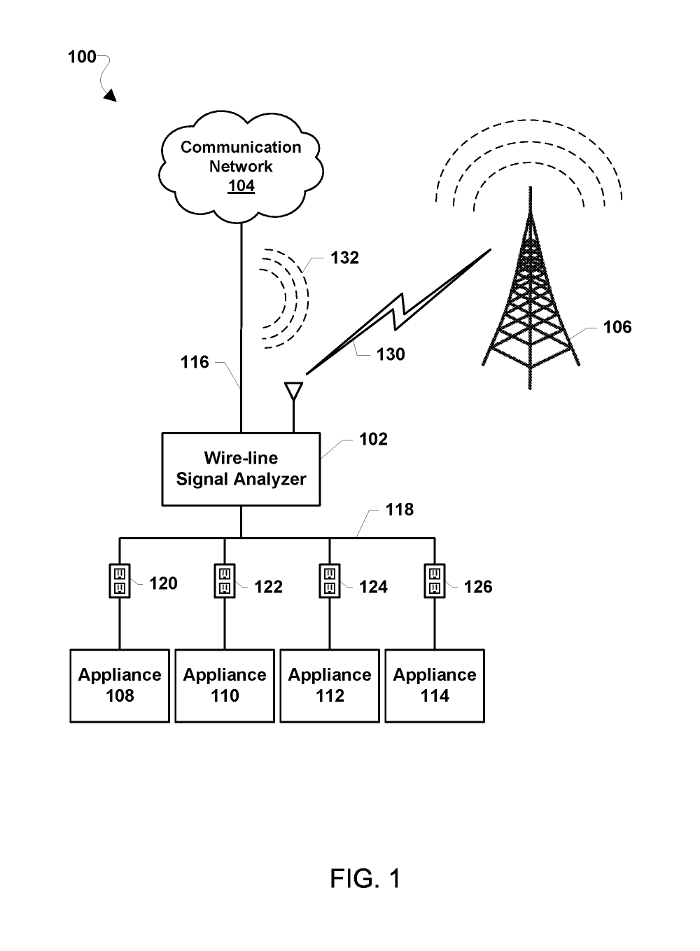

Various embodiments may be implemented in one or more wireless network nodes that may operate within a variety of wire-line communication systems, an example of which is illustrated in FIG. 1. A wire-line communication system 100 may include one or more power line outlets 120-126 that may be electrically coupled to one another via a power line 118. One or more appliances 108-114 may be coupled to the communication network via interconnection with the power line outlets 120-126. Examples of the appliances 108-114 may include a computer, a gaming device, a telephone, a refrigerator, a washing machine, a dryer, a television, a fax machine, a scanner, a printer, a conventional oven, microwave oven, or another appliance that may be configured to communicate via the wire-line communication system 100. The wire-line communication system 100 may enable communication with a communication network 104 through a wired communication link 116. Thus, one of the appliances 108-114 may communicate with another of the appliances 108-114 and/or with the communication network 104. Frequencies used for communication in the wire-line communication system 100 are typically well separated from other signals, such as power-bearing signals. For example, the communication frequency spectrum employed in a power line communication system is typically well above the 60-cycle alternating current power-line frequency used in the United States.

The wire-line communication system 100 may include a wire-line signal analyzer 102. The wire-line signal analyzer 102 may be configured to receive RF signals 130 that may be emitted by a transmitter 106 of a wireless service, for example, a base station, a radio transmission tower, a radar installation, or another transmitter. The wire-line signal analyzer 102 may be configured to determine one or more signal characteristics of RF signals 130. The wire-line signal analyzer 102 may be further configured to determine whether to perform transmit power management based on received RF signals 130 to avoid generating a signal 132 that may interfere with the received RF signal 130 of wireless service. In some implementations, the wire-line signal analyzer 102 may be a component of a larger device, such as a wire-line modem, or the wire-line signal analyzer 102 may be a dedicated device connected to the wire-line communication system 100.

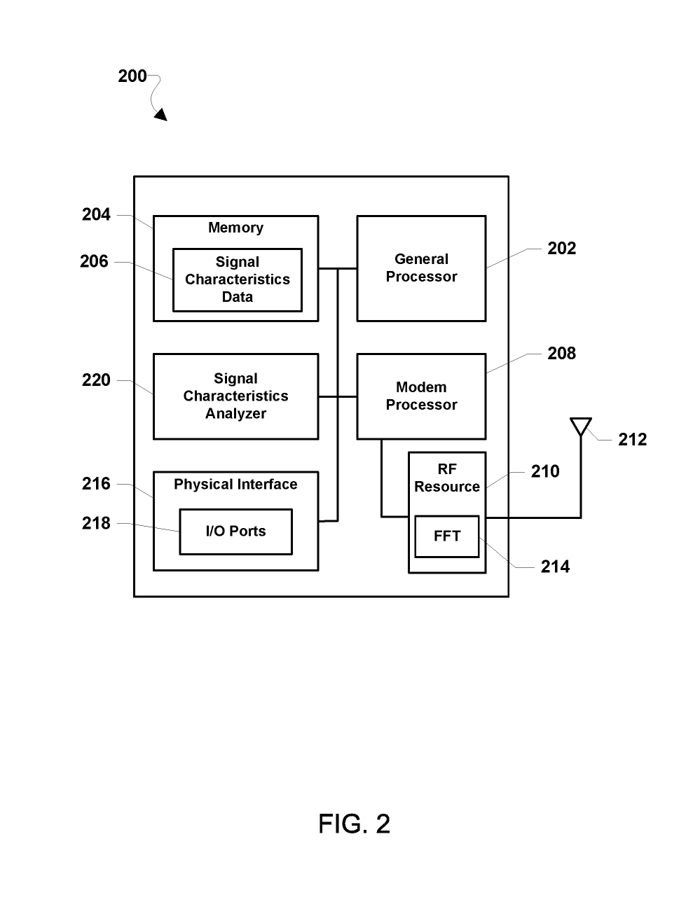

FIG. 2 is a component block diagram of an example of a wire-line signal analyzer 200 suitable for implementing various embodiments. The wire-line signal analyzer 200 may include at least one processor, such as a general processor 202, which may be coupled to at least one memory 204. The memory 204 may be a non-transitory computer-readable storage medium that stores processor-executable instructions. The memory 204 may store an operating system, user application software, and/or other executable instructions that may be loaded into and executed by the general processor 202. The memory 204 may also store application data, such as a database or array data structure. The memory 204 may include one or more caches, read only memory (ROM), random access memory (RAM), electrically erasable programmable ROM (EEPROM), static RAM (SRAM), dynamic RAM (DRAM), or other types of memory. The general processor 202 may read and write information to and from the memory 204. The memory 204 may also store signal characteristics data 206 in a data structure, such as a database or a similar data structure.

The processor 202 and the memory 204 may communicate with at least one modem processor 208. The modem processor 208 may be coupled to an RF resource 210. The RF resource 210 may include various circuitry and components to enable the receiving and processing of radio signals, such as a modulator/demodulator component, a power amplifier, a gain stage, a digital signal processor (DSP), a signal amplifier, a filter, and other such components. The RF resource 210 may be coupled to a wireless antenna (e.g., a wireless antenna 212). The wire-line signal analyzer 200 may include additional RF resources and/or antennas without limitation. In some implementations, the RF resource 210 may include a fast-Fourier transform (FFT) 214 function to enable analysis of the received RF signal. In some implementations, the modem processor 208 may include the FFT 214.

In some embodiments, the processor 202 may also communicate with a physical interface 216 configured to enable a wired connection to another device and/or to a wire-line communication system. The physical interface 216 may include one or more input/output (I/O) ports 218 configured to enable communications with the device to which the wireless network node is connected.

The processor 202 and the memory 204 may also communicate with a signal characteristics analyzer 220. The signal characteristics analyzer 220 may enable the analysis of, and the determination of one or more signal characteristics of, a received RF signal (e.g., the RF signal 130). The signal characteristics analyzer 220 may be implemented in hardware, software, or any combination of hardware and software. The signal characteristics analyzer 220 may also include non-transitory computer-readable storage medium that stores processor-executable instructions to enable analysis of the received RF signal and the determination of one or more signal characteristics.

The wire-line signal analyzer 200 may also include a bus for connecting the various components of the wire-line signal analyzer 200 together, as well as hardware and/or software interfaces to enable communication among the various components. The wire-line signal analyzer 200 may also include various other components not illustrated in FIG. 2. For example, the wire-line signal analyzer 200 may include a number of input, output, and processing components such as buttons, lights, switches, antennas, display screen or touchscreen, various connection ports, additional processors or integrated circuits, and many other components.

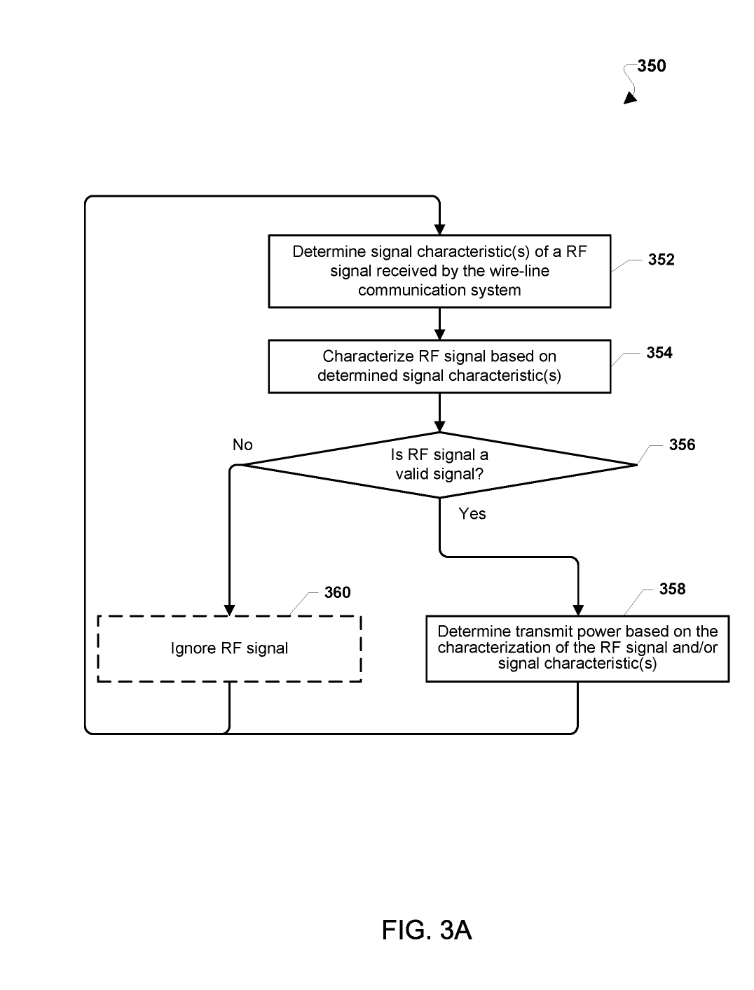

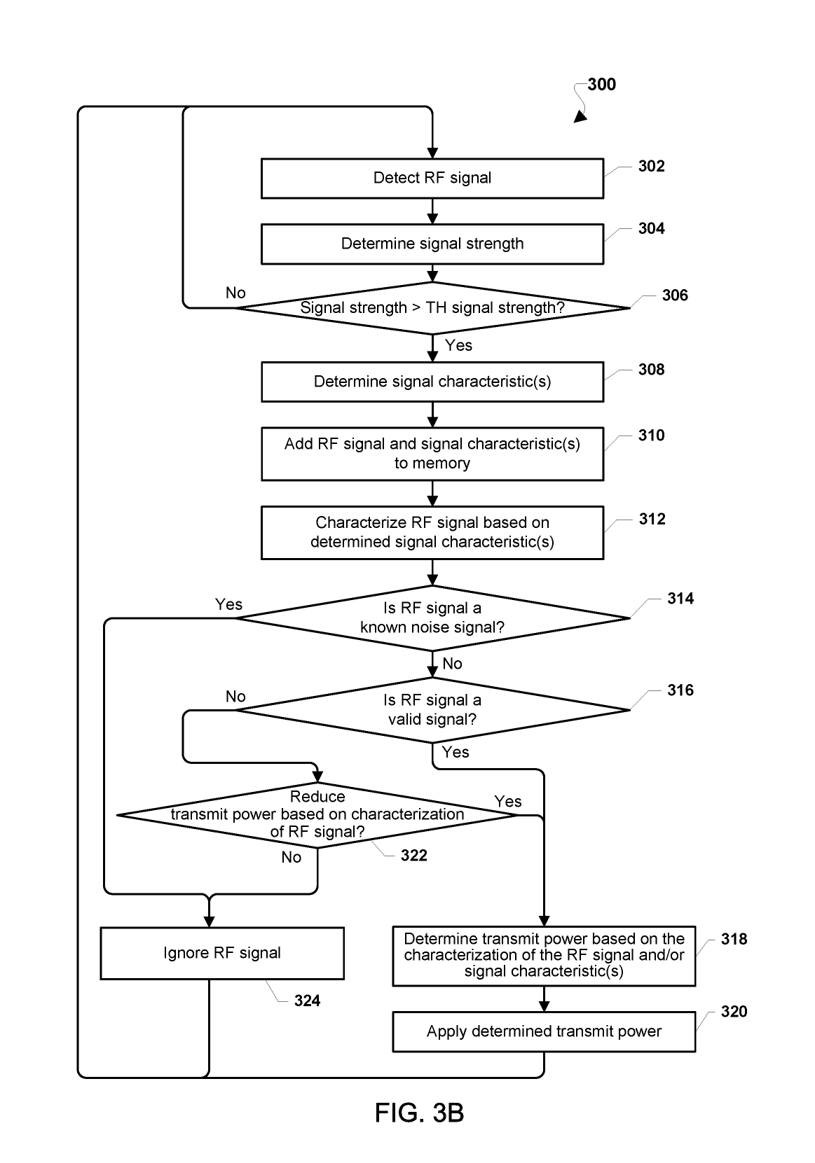

FIG. 3A is a process flow diagram illustrating a method 350 for transmit power management according to some embodiments. With reference to FIGS. 1-3A, the method 350 may be implemented by a processor (e.g., the general processor 202 or another similar processor) of a wire-line signal analyzer (e.g., the wireless wire-line signal analyzer 102, 200).

In block 352, the processor of the wire-line signal analyzer (a “device processor”) may determine one or more signal characteristics of a RF signal received by the wire-line communication system in block 308. Signal characteristics may include, for example, a signal pattern, a bandwidth of the received RF signal, a date and time of receipt of the received RF signal, a duration of the received RF signal, a modulation of the received RF signal, a preamble within the received RF signal, and a channel spacing of the received RF signal.

In block 354, the device processor may characterize the received RF signal based on the determined signal characteristic(s). For example, based on one or more signal characteristics, the device processor may identify the received RF signal as a known noise signal. As another example, the device processor may identify the received RF signal as a valid RF signal for which the wire-line communication system should mitigate interference. In some embodiments, characterizing the received RF signal may include generating a characterization score or a characterization metric.

In determination block 356, the device processor may determine whether the received RF signal is a valid signal. For example, the device processor may compare determined signal characteristics (e.g., frequency, modulation, bandwidth, time of day/day of week, etc.) to a database of known valid signals stored in memory.

In response to determining that the received RF signal is not a valid RF signal (i.e., determination block 356=“No”), the device processor may ignore the RF signal in optional block 360. The device processor may then determine one or more signal characteristics of another RF signal received by the wire-line communication system in block 352.

In response to determining that the received RF signal is a valid RF signal (i.e., determination block 356=“Yes”), the device processor may determine the transmit power based on the characterization of the received RF signal and/or one or more signal characteristics in block 358. For example, the device processor may reduce the transmit power of a signal from the wire-line communication system in the frequency range of the received RF signal. The device processor may then determine one or more signal characteristics of another RF signal received by the wire-line communication system in block 352.

FIG. 3B is a process flow diagram illustrating a method 300 for transmit power management according to some embodiments. With reference to FIGS. 1-3B, the method 300 may be implemented by a processor (e.g., the general processor 202 or another similar processor) of a wire-line signal analyzer (e.g., the wireless wire-line signal analyzer 102, 200).

In block 302, the processor of the wire-line signal analyzer (a “device processor”) may detect an RF signal (e.g., the received RF signal 130). For example, the device processor may monitor one or more RF frequency ranges for an RF signal.

In block 304, the device processor may determine a signal strength of a received RF signal.

In determination block 306, the device processor may determine whether the signal strength of the detected RF signal exceeds a threshold signal strength. In response to determining that the signal strength of the received RF signal does not exceed the threshold signal strength (i.e., determination block 306=“No”), the device processor may continue monitoring for RF signals in block 302.

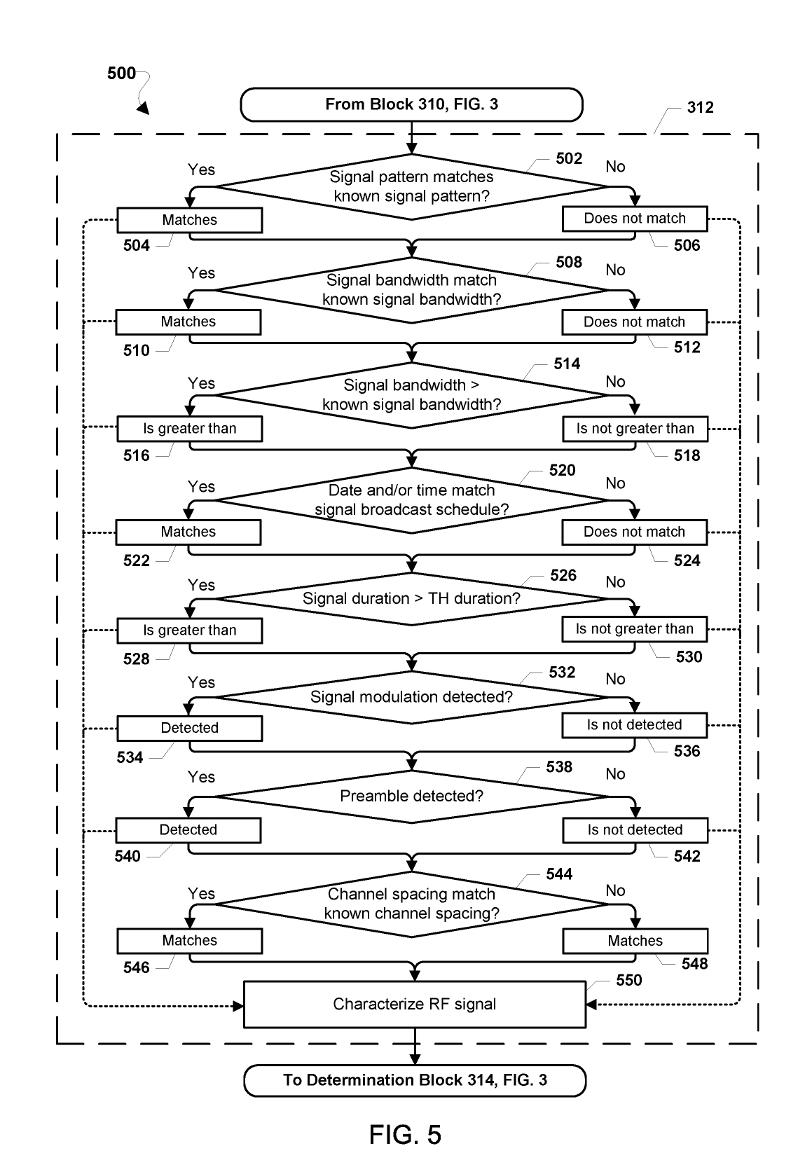

In response to determining that the signal strength of the received RF signal exceeds the threshold signal strength (i.e., determination block 306=“Yes”), the device processor may determine one or more signal characteristics of the received RF signal in block 308. Signal characteristics may include, for example, a signal pattern, a bandwidth of the received RF signal, a date and time of receipt of the received RF signal, a duration of the received RF signal, a modulation of the received RF signal, a preamble within the received RF signal, and a channel spacing of the received RF signal. Further details regarding operations that may be performed by the device processor in block 308 are described with reference to FIG. 5.

In block 310, the device processor may add the received RF signal and the determined signal characteristic(s) to a data structure stored in memory (e.g., memory 204) of the wire-line signal analyzer. In some implementations, the device processor may store the received RF signal and the determined signal characteristic(s) in a database or another similar data structure.

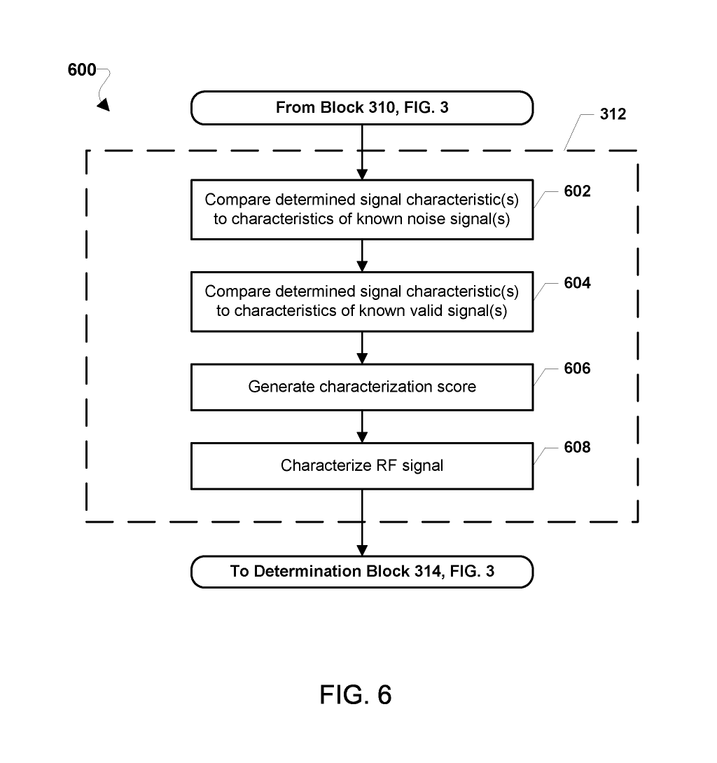

In block 312, the device processor may characterize the received RF signal based on the determined signal characteristic(s). For example, based on one or more signal characteristics, the device processor may identify the received RF signal as a known noise signal. As another example, the device processor may identify the received RF signal as a valid RF signal for which the wire-line communication system should mitigate interference. In some embodiments, characterizing the received RF signal may include generating a characterization score or a characterization metric. Further details regarding operations that may be performed by the device processor in block 312 are described with reference to FIGS. 5 and 6.

In determination block 314, the device processor may determine whether the received RF signal is a known noise signal based upon the characterization performed in block 312.

In response to determining that the received RF signal is a known noise signal (i.e., determination block 314=“Yes”), the device processor may ignore the received RF signal in block 324. For example, the device processor may not reduce or otherwise alter a signal transmit power in the frequency range of the received RF signal. The device processor may then continue monitoring for RF signals in block 302.

In response to determining that the received RF signal is not a known noise signal (i.e., determination block 314=“No”), the device processor may determine whether the received RF signal is a valid signal in determination block 316. For example, the device processor may compare determined signal characteristics (e.g., frequency, modulation, bandwidth, time of day/day of week, etc.) to a database of known valid signals stored in memory.

In response to determining that the received RF signal is not a valid RF signal (i.e., determination block 316=“No”), the device processor may determine whether to reduce a transmit power based on the characterization of the received RF signal in determination block 322. For example, in embodiments in which characterizing the received RF signal includes generating a characterization score or a characterization metric, the device processor may compare the generated characterization score or metric with one or more thresholds. In some embodiments, such thresholds may be based on one or more aspects of known noise signals. In some embodiments, such thresholds may be based on one or more aspects of known valid signals. Thus, even in cases in which the device processor is unable to definitively determine whether the received RF signal is a known noise signal or a valid signal, the device processor may determine whether to reduce the transmit power based on the characterization of the received RF signal.

In response to determining not to reduce transmit power based on the characterization of the received RF signal (i.e., determination block 322=“No”), the device processor may ignore the received RF signal in block 324. The device processor may then continue monitoring for RF signals in block 302.

In response to determining that the received RF signal is a valid RF signal (i.e., determination block 316=“Yes”), or in response to determining to reduce transmit power based on the characterization of the received RF signal (i.e., determination block 322=“Yes”), the device processor may determine the transmit power based on the characterization of the received RF signal and/or one or more signal characteristics in block 318. For example, the device processor may reduce the transmit power of a signal from the wire-line communication system in the frequency range of the received RF signal.

In some implementations, the device processor may fine-tune the reduction of the transmit power (e.g., the “notch”) determined in block 318 based on the characterization of the received RF signal and/or one or more signal characteristics. For example, the device processor may narrow the frequency range in which the transmit power is reduced based on the determined signal pattern (e.g., the shape of the waveform of the received RF signal) to “cut out” a notch closely corresponding to the received signal. As another example, the device processor may use the signal bandwidth of the received RF signal to narrowly tailor the range in which the device processor reduces signal transmit power. As another example, the device processor may use a periodicity or repetitiveness of a duration of the received RF signal to determine time periods in which to reduce the transmit power, and to determine other time periods in which to not reduce transmit power. In some implementations, the device processor may analyze the received RF signal over time, and may narrow or reduce the “notch” (i.e., the frequency range in which the device processor reduces transmit power) based on the analysis of the detected RF signal over time. Fine-tuning the reduction of the transmit power may increase the amount of bandwidth available to the wire-line communication system for data communication.

In block 320, the device processor may apply the determined transmit power to one or more signals transmitted from the wire-line communication system. The device processor may also continue monitoring for more RF signals in block 302.

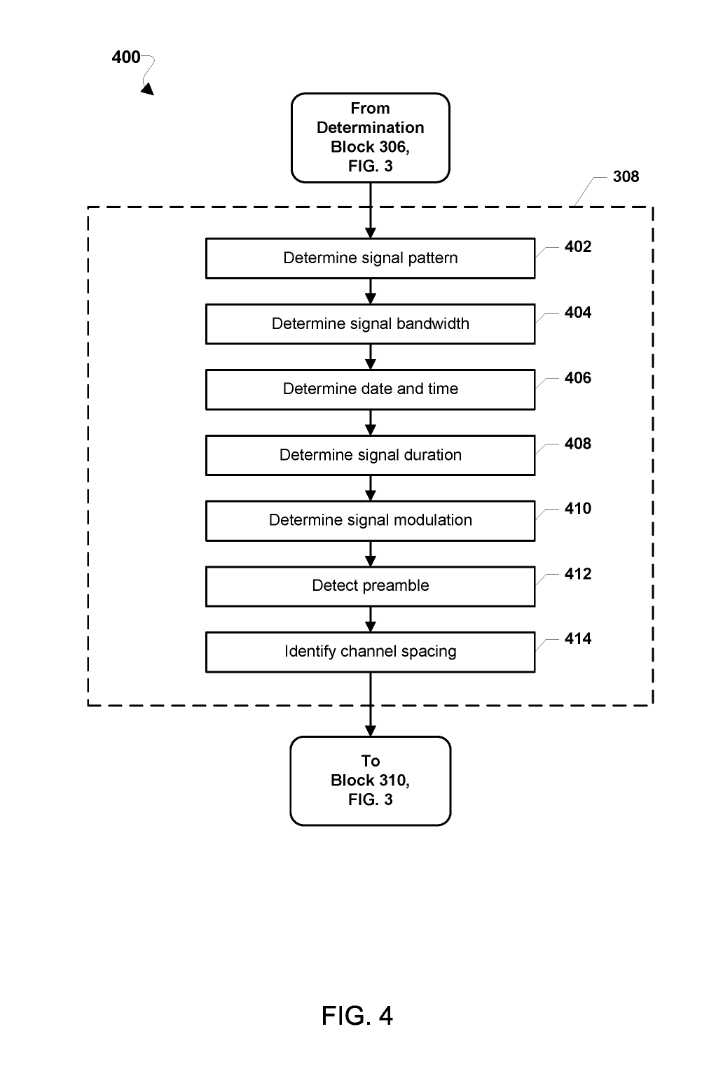

FIG. 4 is a process flow diagram illustrating an example of operations 400 that may be performed in block 308 of the method 300 as described with reference to FIG. 3 according to some embodiments. With reference to FIGS. 1-4, the operations 400 may be implemented by a processor (e.g., the general processor 202 or another similar processor) of a wire-line signal analyzer (e.g., the wireless wire-line signal analyzer 102, 200). The order of operations performed in blocks 402-414 is merely illustrative, and the operations of blocks 402-414 may be performed in any order in various embodiments.

In response to determining that the signal strength of the received RF signal exceeds the threshold signal strength (i.e., determination block 306 of the method 300=“Yes”), the device processor of the wire-line signal analyzer may determine a signal pattern of a received RF signal in block 402. The signal pattern may include a waveform of the received RF signal. The waveform may include an amplitude plotted against time shape of the received RF signal in the time domain.

In block 404, the device processor may determine a signal bandwidth. The signal bandwidth may include a range of frequencies (e.g., in kHz or MHz) over which the device processor detects the received RF signal.

In block 406, the device processor may determine a date and time of reception of the received RF signal.

In block 408, the device processor may determine a signal duration. The duration of the received RF signal may include a period of time over which the device processor detects the received RF signal. For example, the device processor may detect the received RF signal for a period of time (e.g., a number of seconds). The duration of the received RF signal may also include a periodicity or a repetitiveness of the received RF signal. For example, a single instance of the received RF signal may be relatively short, but the device processor may detect a regularity of the received RF signal, such as a repetition or a repetitive pattern of the received RF signal.

In block 410, the device processor may determine a signal modulation. For example, the device processor may detect phase modulation, amplitude modulation (AM) or frequency modulation (FM) within the received RF signal. The device processor may also determine a type of modulation within the received RF signal, such as whether the received RF signal includes orthogonal frequency division modulation (OFDM) or another similar modulation. Other types of modulation may be detected or determined in block 410.

In block 412, the device processor may detect a preamble in the received RF signal. For example, if the received RF signal is modulated to carry data, the device processor may detect an encoding structure of information within the received RF signal. In some implementations, the device processor may recognize a detected encoding structure as corresponding to a preamble. Detecting an encoding structure or preamble may enable the device processor to identify the received RF signal as an information bearing signal. The device processor may also identify the received RF signal as a particular type of signal based on the presence of the encoding structure or preamble.

In block 414, the device processor may identify a channel spacing in the received RF signal. For example, the device processor may detect two or more channels (or carriers) within the received RF signal. As one example, OFDM, AM, and FM signals typically include a known channel (or carrier) spacing.

Using the determinations made in blocks 402-414, device processor may perform operations as described in block 310 and the rest of the method 300 as described with reference to FIG. 3.

FIG. 5 is a process flow diagram illustrating operations 500 that may be performed in block 312 of the method 300 according to some embodiments. With reference to FIGS. 1-5, the operations 500 may be implemented by a processor (e.g., the general processor 202 or another similar processor) of a wire-line signal analyzer (e.g., the wireless wire-line signal analyzer 102, 200). The order of operations performed in determination blocks 502-550 is merely illustrative, and the operations of blocks 502-550 may be performed in any order in various embodiments.

As described above with regard to the method 300 (FIG. 3), after performing the operations described with respect to block 310, the device processor may characterize the received RF signal based on the determined signal characteristic(s) in block 312. In characterizing the received RF signal based on the determined signal characteristic(s), the device processor may perform one or more determinations about the received RF signal that may yield one or more indications regarding the likelihood that the received RF signal is a noise signal, a valid signal, or as a signal that is not valid. Some examples of such determination operations are illustrated as a method 500 in FIG. 5. In various embodiments, the device processor may perform one or more of operations of blocks 502-544 to make one or more determinations about the received RF signal. In some embodiments, the determinations of the method 500 may compare the determined signal characteristic(s) with a priori information. In some embodiments, the result of one or more of the determinations in blocks 502-544 may be sufficiently definitive that the device processor may proceed from a result to characterize the received RF signal in block 550.

For example, the device processor may determine whether the signal pattern of the received RF signal matches a known signal pattern in determination block 502. For example, the device processor may compare the signal pattern of the received RF signal to one or more signal patterns that are stored in a memory of the wire-line signal analyzer (e.g., the memory 204 and/or the signal characteristics data 206). Known signal patterns may include signal patterns of known information-bearing signals, such as radio broadcasts, cellular communication signals, satellite communication signals, a radar signal, or another information-bearing signals. Known signal patterns may also include patterns of known noise signals, such as RF signals that may be generated by a power amplifier, by other electrical appliances or equipment, or even by a natural phenomenon that produces RF noise. The operations of comparing the received RF signal pattern to patterns stored in memory may involve determining whether there is a match within a predetermine threshold of similarity using any of a variety of pattern comparison methods or algorithms.

In response to determining that the signal pattern of the received RF signal matches a known signal pattern (i.e., determination block 502=“Yes”), the device processor may generate an indication that the signal pattern matches a known signal pattern in operation 504. In some implementations, the device processor may also generate information identifying the known signal pattern matched by the signal pattern of the received RF signal. In some implementations and/or cases, the device processor may determine that the match of the known signal pattern is sufficiently close or strong (e.g., a percentage match or metric relating the degree of matching) that the received RF signal can be characterized in block 550 on the basis of the matching alone. For example, if the device processor determines that the received RF signal pattern (e.g., frequency, modulation, etc.) closely matches a known licensed broadcast signal, the frequency can be characterized in block 550 as a valid signal for which interference should be avoided via appropriate management of the transmit frequency and power.

In response to determining that the signal pattern of the received RF signal does not match a known signal pattern (i.e., determination block 502=“No”), the device processor may generate an appropriate indication in block 506 that may be used as part of characterizing the received RF signal. In some implementations and/or cases, the device processor may determine that the lack of match to a known signal pattern is sufficient (i.e., is sufficiently different from a known signal pattern, such as when a threshold number of aspects do not match, or a threshold number of matches is not reached) that the processor may characterize the received RF signal in block 550 without further evaluations.

In determination block 508, the device processor may determine whether the signal bandwidth of the received RF signal matches a known signal bandwidth. For example, certain RF communication systems, such as terrestrial and satellite radio, cellular communication systems, and other similar systems, use RF signals having known signal bandwidths. As one example, Digital Radio Mondiale, a radio broadcasting system, typically uses signal bandwidths of approximately 18 kHz and/or 20 kHz (and, in some cases, bandwidths of approximately 4.5 kHz, 5 kHz, 8 kHz, and/or 10 kHz).

In response to determining that the signal bandwidth of the received RF signal matches a known signal bandwidth (i.e., determination block 508=“Yes”), the device processor may generate an indication that the signal bandwidth matches a signal bandwidth in operation 510. In some implementations, the device processor may also generate information identifying the known signal bandwidth matched by the signal bandwidth of the received RF signal (e.g., an 18 kHz bandwidth of a radio broadcast). In some implementations and/or cases, the device processor may determine that the match to the known signal bandwidth is sufficiently close (e.g., a threshold number of aspects match) to enable characterizing the received RF signal in block 550 without further evaluations, particularly in combination with other determinations that have been made.

In response to determining that the signal bandwidth of the received RF signal does not match a known signal bandwidth (i.e., determination block 508=“No”), the device processor may generate an indication that the signal bandwidth does not match a known signal bandwidth in operation 512. In some implementations and/or cases, the device processor may determine that the lack of a match to a known signal bandwidth is sufficient (e.g., a threshold number of aspects do not match, or a threshold number of matches is not reached) that the processor may characterize the received RF signal in block 550 without further evaluations, particularly in combination with other determinations that have been made.

In determination block 514, the device processor may determine whether the signal bandwidth of the received RF signal exceeds a known signal bandwidth. For example, a signal bandwidth that exceeds a known signal bandwidth may not conform to known information-bearing signals (e.g., signals typically used by known communication and other systems). Such an RF signal may tend to be a non-valid RF signal, such as a noise signal, or another RF signal for which the wireless line communication system does not is not required to reduce transmit power levels.

In response to determining that the signal bandwidth of the received RF signal exceeds a known signal bandwidth (i.e., determination block 514=“Yes”), the device processor may generate an indication that the signal bandwidth exceeds a known signal bandwidth in operation 516. In some implementations, the signal bandwidth of the received RF signal may be sufficiently greater than a known bandwidth signal such that the processor may characterize the received RF signal in block 550 without further evaluations, particularly in combination with other determinations that have been made.

In response to determining that the signal bandwidth of the received RF signal does not exceed a known signal bandwidth (i.e., determination block 514=“No”), the device processor may generate an indication that the signal bandwidth does not exceed a known signal bandwidth in operation 518. In some implementations, the determination that the signal bandwidth of the received RF signal does not exceed a known signal bandwidth may be sufficient to enable the processor to characterize the received RF signal in block 550. In some implementations, the signal bandwidth of the received RF signal may be sufficiently less than a known signal bandwidth (e.g., by a threshold amount) such that the processor may characterize the received RF signal in block 550 without further evaluations, particularly in combination with other determinations that have been made.

In determination block 520, the device processor may determine whether the date and/or time of receipt of the received RF signal matches a signal broadcast schedule. For example, radio broadcasts (e.g., AM, FM, Digital Radio Mondiale, and others) typically conform to a published broadcast schedule. In some implementations, the device processor may compare the date and/or time of receipt of the received RF signal to one or more published broadcast schedules that may be stored in memory.

In response to determining that the date and/or time of receipt of the received RF signal matches the signal broadcast schedule (i.e., determination block 520=“Yes”), the device processor may generate an indication that the date and/or time of receipt of the received RF signal matches the signal broadcast schedule in operation 522. In some implementations, the determination of the match, or the degree of the match, may be sufficient in combination with other determinations to enable the device processor to characterize the received RF signal in block 550 without further evaluations.

In response to determining that the date and/or time of receipt of the received RF signal does not match the signal broadcast schedule (i.e., determination block 520=“No”), the device processor may generate an indication that the date and/or time of receipt of the received RF signal does not match the signal broadcast schedule in operation 524. In some implementations, the determination of the lack of a match, or the degree of divergence, may be sufficient in combination with other determinations to enable the device processor to characterize the received RF signal in block 550 without further evaluations.

In determination block 526, the device processor may determine whether a signal duration of the received RF signal exceeds a threshold duration. In some implementations, the device processor may determine whether a continuous duration of the received RF signal exceeds the threshold duration. However, some RF signals may include a plurality of short signals that are nonetheless repetitive or recur in an identifiable pattern (for example, radar signals). In some implementations, the device processor may determine whether a repetition or pattern of the received RF signal exceeds a threshold level of repetitiveness or regularity.

In response to determining that the duration of the received RF signal exceeds the threshold duration (i.e., determination block 526=“Yes”), the device processor may generate an indication that the duration of the received RF signal exceeds the threshold duration in operation 528. In some implementations, the duration of the received RF signal may be sufficiently greater than the threshold duration (e.g., greater than a threshold) that the device processor may characterize the received RF signal in block 550 without further evaluations, particularly in combination with other determinations that have been made.

In response to determining that the duration of the received RF signal does not exceed the threshold duration (i.e., determination block 526=“No”), the device processor may generate an indication that the duration of the received RF signal does not exceed the threshold duration in operation 530. In some implementations, the determination that the duration of the received RF signal does not exceed the threshold duration may be sufficient in combination with other determinations to enable the processor to characterize the received RF signal in block 550 without further evaluations. In some implementations, the duration of the received RF signal may be sufficiently less than the threshold duration (e.g., by a threshold amount) that the processor may characterize the received RF signal in block 550 without further evaluations, particularly in combination with other determinations that have been made.

In determination block 532, the device processor may determine whether the device processor detects a signal modulation in the received RF signal. For example, FM and AM radio signals typically utilize a readily detectable signal modulation, the presence of which may increase the likelihood that the received RF signal is an information-bearing signal.

In response to determining that the device processor detects a signal modulation within the received RF signal (i.e., determination block 532=“Yes”), the device processor may generate an indication that a signal modulation is detected in the received RF signal in operation 534. In some implementations, detection of a signal modulation may be sufficient in combination with other determinations to enable the processor to characterize the received RF signal in block 550 without further evaluations.

In response to determining that the device processor does not detect a signal modulation within the received RF signal (i.e., determination block 532=“No”), the device processor may generate an indication that signal modulation is not detected in the received RF signal in operation 536. In some implementations, the determination that signal modulation is not detected may be sufficient in combination with other determinations to enable the processor to characterize the received RF signal in block 550 without further evaluations.

In determination block 538, the device processor may determine whether the device processor detects a preamble in the received RF signal. In some implementations, the device processor may detect a structure of encoded information within the received RF signal that corresponds to a data preamble or similar data structure.

In response to determining that the device processor detects a preamble of the received RF signal (i.e., determination block 538=“Yes”), the device processor may generate an indication that the preamble is detected in the received RF signal in operation 540. Detecting the encoding structure or preamble may enable the device processor to identify the received RF signal as an information bearing signal. In some implementations, the device processor may also identify the received RF signal as a particular type of signal based on the presence of the encoding structure or preamble. In some implementations, the determination that the preamble is detected may be sufficient in combination with other determinations to enable the processor to characterize the received RF signal in block 550 without further evaluations.

In response to determining that the device processor does not detect a preamble in the received RF signal (i.e., determination block 538=“No”), the device processor may generate an indication that the preamble is not detected in the received RF signal in operation 542. In some implementations, the determination that the preamble is not detected may be sufficient in combination with other determinations to enable the processor to characterize the received RF signal in block 550 without further evaluations.

In determination block 544, the device processor may determine whether a channel spacing of the received RF signal matches a known channel spacing. For example, the device processor may detect two or more channels (or carriers) within the received RF signal, and may determine a frequency spacing between the two or more channel or carriers. As one example, OFDM, AM, and FM signals each typically include a known channel (or carrier) spacing. Detection of a known channel spacing in the received RF signal may provide additional indication that the received RF signal is a valid or information-bearing signal.

In response to determining that the channel spacing matches the known channel spacing (i.e., determination block 544=“Yes”), the device processor may generate an indication that the channel spacing matches the known channel spacing in operation 546.

In response to determining that the channel spacing does not match the known channel spacing (i.e., determination block 544=“No”), the device processor may generate an indication that the channel spacing does not match the known channel spacing in operation 548.

In block 550, the device processor may characterize the received RF signal based on indications resulting from the various evaluations made in determination blocks 502, 508, 514, 520, 526, 532, 538, and/or 544. For example, in block 550 the device processor may apply a decision making algorithm to the one or more indications generated in operations 504, 506, 510, 512, 516, 518, 522, 524, 528, 530, 534, 536, 540, 542, 546, and 548 to characterize the received RF signal as one of a valid signal (that is, a signal for which the wire-line communication device must reduce a signal transmit power), a known noise signal, or as a non-valid signal. This characterization may then be applied in determination block 314 of the method 300 as described with reference to FIG. 3. In some embodiments, characterizing the received RF signal may include generating a characterization score or a characterization metric based on the result of one or more of the operations of determination blocks 502-544. In some embodiments, even in cases where the device processor is unable to definitively determine whether an RF signal is a known noise signal or a valid signal based on the result of one or more of determination blocks 502-544, the device processor may determine whether to reduce the transmit power based on the characterization score or metric.

FIG. 6 is a process flow diagram illustrating operations 600 that may be performed in block 312 of the method 300 according to some embodiments. With reference to FIGS. 1-6, the operations 600 may be implemented by a processor (e.g., the general processor 202 or another similar processor) of a wire-line signal analyzer (e.g., the wireless wire-line signal analyzer 102, 200). The order of operations performed in determination blocks 602-606 is merely illustrative, and the operations of blocks 602-606 may be performed in any order in various embodiments.

As described above with regard to the method 300 (FIG. 3), after performing the operations described with respect to block 310, the device processor may characterize the received RF signal based on the determined signal characteristic(s) in block 312.

For example, in block 602, the device processor may compare the one or more determined signal characteristics to characteristics of one or more known noise signals. In some embodiments, the device processor may determine whether one or more of the signal characteristics matches one or more of the characteristics of the known noise signals. In some embodiments, the device processor may determine whether one or more of the signal characteristics is within a threshold variance from one or more of the characteristics of the known noise signals.

In block 604, the device processor may compare the one or more determined signal characteristics to characteristics of one or more known valid signals. In some embodiments, the device processor may determine whether one or more of the signal characteristics matches one or more of the characteristics of the valid noise signals. In some embodiments, the device processor may determine whether one or more of the signal characteristics is within a threshold variance from one or more of the characteristics of the known valid signals.

In block 606, the device processor may generate a characterization score. In some embodiments, the characterization score may be based on one or more of the determined signal characteristics. In some embodiments, the characterization score may be based on one or more of the operations of blocks 602 and 604. In some embodiments, the characterization score may be based on a similarity of one or more of the determined signal characteristics to one or more of the characteristics of the known noise signals and/or the known valid signals. In some embodiments, the characterization score may be based on a difference between one or more of the determined signal characteristics to one or more of the characteristics of the known noise signals and/or the known valid signals. Even in cases in which the device processor is unable to definitively determine whether an RF signal is a known noise signal or a valid signal (e.g., based on the operations of block 602 and/or block 604), the device processor may use the characterization score to determine whether to reduce the transmit power.

In block 608, the device processor may characterize the received RF signal based on one or more of the operations of blocks 602-608. The characterization of the received RF signal may then be applied in determination block 314 of the method 300 as described with reference to FIG. 3.

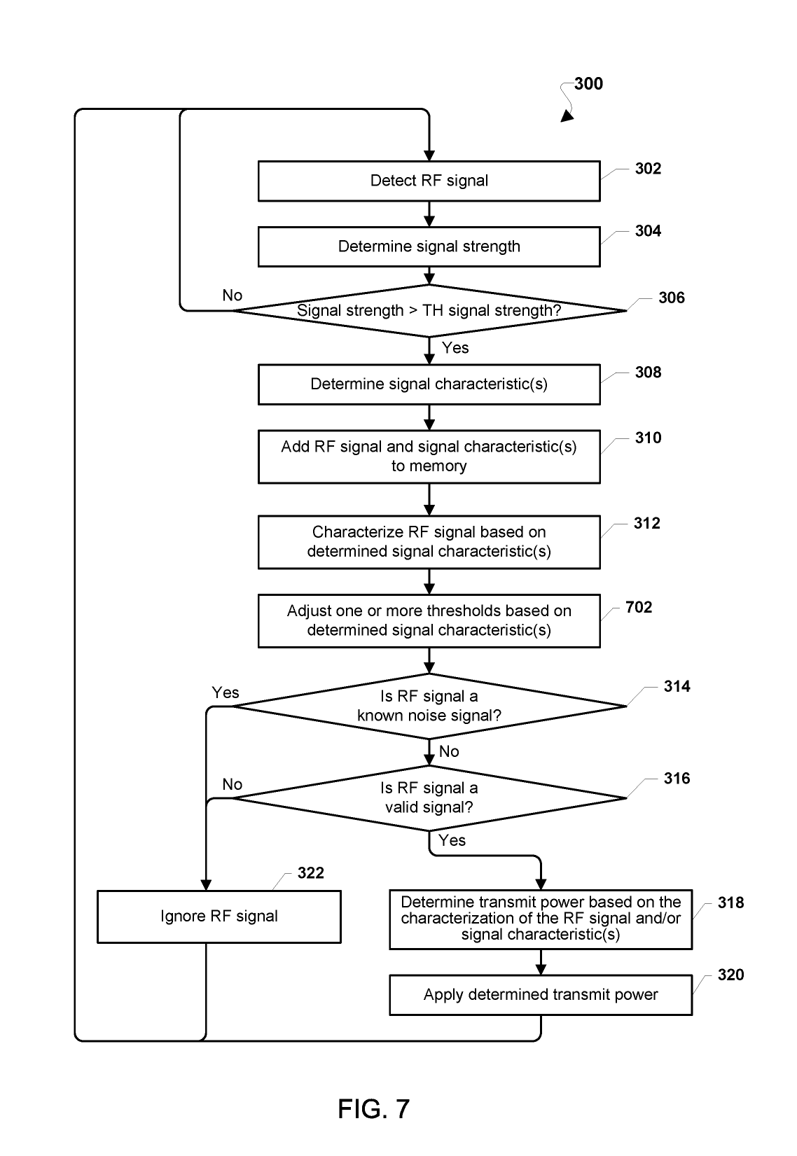

FIG. 7 is a process flow diagram illustrating a method 700 for transmit power management according to some embodiments. With reference to FIGS. 1-7, the method 700 may be implemented by a processor (e.g., the general processor 202 or another similar processor) of a wire-line signal analyzer (e.g., the wireless wire-line signal analyzer 102, 200). In blocks 302-322, the device processor may perform operations of like-numbered blocks of the method 300 as described with reference to FIG. 3.

In block 702, the device processor may adjust one or more thresholds based on one or more of the determined signal characteristics. For example, in various implementations, the device processor may observe and build up over time information about regularly detected RF signals. In some implementations, the device processor may observe signals and evaluate/characterize the observed signals based on information detected during a sliding window duration of time (e.g., over the previous 10 seconds). Based on one or more of the determined signal characteristics (or based on one or more of the determined signal characteristics over time), the device processor may adjust one or more thresholds to increase sensitivity for detection of one or more signal characteristics of an RF signal that may enable the received RF signal to be determined as a valid signal (i.e., a signal requiring transmit power management). In some implementations, the device processor may adjust one or more thresholds to decrease sensitivity for detection of one or more signal characteristics representative of an RF signal that is determined to be a known noise signal, or an RF signal that is not valid.

For example, the device processor may be configured to determine that received RF signals with a signal strength substantially greater than the signal strength threshold are typically valid signals, and therefore increase the signal strength threshold that the device processor uses to characterize RF signals as valid signals. As another example, the device processor may determine that received RF signals exhibiting a relatively low duration but having very high repetitiveness are valid signals, which case the device processor may decrease the threshold duration that the device processor uses to characterize received RF signals as valid signals.

The various embodiments and implementations may enable a wire-line communication system to make rapid, accurate decisions about whether to reduce transmit power in one or more frequencies of a detected RF signal, thereby preserving wire-line bandwidth for communications while avoiding causing interference with wireless communication systems of another wireless service. Further, the various embodiments and implementations may also increase overall wire-line communication capacity.

Various embodiments and implementations illustrated and described are provided merely as examples to illustrate various features of the claims. However, features shown and described with respect to any given embodiment are not necessarily limited to the associated embodiment or implementation and may be used or combined with other embodiments that are shown and described. Further, the claims are not intended to be limited by any one example embodiment. For example, one or more of the operations of the methods 300, 350, 400, 500, 600, and 700 may be substituted for or combined with one or more operations of the methods 300, 350, 400, 500, 600, and 700.

The foregoing method descriptions and the process flow diagrams are provided merely as illustrative examples and are not intended to require or imply that the blocks of various embodiments and implementations must be performed in the order presented. As will be appreciated by one of skill in the art the order of blocks in the foregoing embodiments and implementations may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments and implementations disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, various embodiments are not intended to be limited to the embodiments shown herein but are to be accorded the widest scope consistent with the following claims and the principles and novel features disclosed herein.

1. A method of transmit power management in a wire-line communication system, comprising:
determining one or more signal characteristics of a radio frequency (RF) signal received by the wire-line communication system;
characterizing the received RF signal based on the one or more signal characteristics;
determining whether the received RF signal is a valid signal based on the characterization of the received signal; and
determining a transmit power for a signal from the wire-line communication system based on the characterization of the received RF signal when the received RF signal is a valid signal.

2. The method of claim 1, further comprising:
ignoring the received RF signal in response to determining that the received RF signal is not a valid signal.

3. The method of claim 1, further comprising:
determining whether to reduce the transmit power for the signal from the wire-line communication system based on the characterization of the received RF signal in response to determining that the received RF signal is not a valid signal; and
determining the transmit power for a signal from the wire-line communication system based on the characterization of the received RF signal in response to determining to reduce the transmit power based on the characterization of the received RF signal.

4. The method of claim 3, further comprising:
ignoring the received RF signal in response to determining not to reduce the transmit power based on the characterization of the received RF signal.

5. The method of claim 1, further comprising:
determining whether the received RF signal is a known noise signal; and
ignoring the received RF signal in response to determining that the received RF signal is a known noise signal.

6. The method of claim 1, wherein the one or more signal characteristics are selected from the group consisting of a signal pattern, a signal bandwidth, a date and time of reception, a signal duration, a signal modulation, a signal preamble, and a channel spacing.

7. The method of claim 1, wherein characterizing the received RF signal based on the one or more signal characteristics comprises determining whether a signal pattern matches a known signal pattern.

8. The method of claim 1, wherein characterizing the received RF signal based on the one or more signal characteristics comprises determining whether a signal bandwidth matches a known signal bandwidth.

9. The method of claim 1, wherein characterizing the received RF signal based on the one or more signal characteristics comprises determining whether a signal bandwidth exceeds a known signal bandwidths.

10. The method of claim 1, wherein characterizing the received RF signal based on the one or more signal characteristics comprises determining whether a date and time of reception of the received RF signal matches a signal broadcast schedule.

11. The method of claim 1, wherein characterizing the received RF signal based on the one or more signal characteristics comprises determining whether a duration of the received RF signal exceeds a threshold duration.

12. The method of claim 1, wherein characterizing the received RF signal based on the one or more signal characteristics comprises determining whether a preamble is detected.

13. The method of claim 1, wherein characterizing the received RF signal based on the one or more signal characteristics comprises determining whether signal modulation is detected.

14. The method of claim 1, wherein characterizing the received RF signal based on the one or more signal characteristics comprises determining whether a channel spacing of the received RF signal matches one or more known channel spacings.

15. The method of claim 1, wherein characterizing the received RF signal based on the one or more signal characteristics comprises determining a characterization score based on the one or more signal characteristics.

16. The method of claim 1, wherein characterizing the received RF signal based on the one or more signal characteristics comprises comparing the one or more determined signal characteristics to characteristics of one or more known noise signals.

17. The method of claim 1, wherein characterizing the received RF signal based on the one or more signal characteristics comprises comparing the one or more determined signal characteristics to characteristics of one or more known valid signals.

18. The method of claim 1, further comprising adding the received RF signal and the one or more signal characteristics to a memory of the wire-line communication system.

19. A wire-line signal analyzer configured for use in a wire-line communication system, comprising:
a radio frequency (RF) resource configured to receive RF signals; and
a processor coupled to the RF resource and configured with processor-executable instructions to:
determine one or more signal characteristics of a received RF signal received by the RF resource;
characterize the received RF signal based on the one or more signal characteristics;
determine whether the received RF signal is a valid signal based on the characterization of the received signal; and
determine a transmit power for a signal from the wire-line communication system based on the characterization of the received RF signal when the received RF signal is a valid signal.

20. The wire-line signal analyzer of claim 19, wherein the processor is further configured with processor-executable instructions to:
ignore the received RF signal in response to determining that the received RF signal is not a valid signal.

21. The wire-line signal analyzer of claim 19, wherein the processor is further configured with processor-executable instructions to:
determine whether to reduce the transmit power for the signal from the wire-line communication system based on the characterization of the received RF signal in response to determining that the received RF signal is not a valid signal; and
determine the transmit power for a signal from the wire-line communication system based on the characterization of the received RF signal in response to determining to reduce the transmit power based on the characterization of the received RF signal.

22. The wire-line signal analyzer of claim 3, wherein the processor is further configured with processor-executable instructions to:
ignore the received RF signal in response to determining not to reduce the transmit power based on the characterization of the received RF signal.

23. The wire-line signal analyzer of claim 19, wherein the processor is further configured with processor-executable instructions to:
determine whether the received RF signal is a known noise signal; and
ignore the received RF signal in response to determining that the received RF signal is a known noise signal.

24. The wire-line signal analyzer of claim 19, wherein the one or more signal characteristics are selected from the group consisting of a signal pattern, a signal bandwidth, a date and time of reception, a signal duration, a signal modulation, a signal preamble, and a channel spacing.

25. The wire-line signal analyzer of claim 19, wherein the processor is configured with processor-executable instructions to characterize the received RF signal based on the one or more signal characteristics by determining whether a signal pattern matches a known signal pattern.

26. The wire-line signal analyzer of claim 19, wherein the processor is configured with processor-executable instructions to characterize the received RF signal based on the one or more signal characteristics by determining whether a signal bandwidth matches a known signal bandwidth.

27. The wire-line signal analyzer of claim 19, wherein the processor is configured with processor-executable instructions to characterize the received RF signal based on the one or more signal characteristics by determining whether a signal bandwidth exceeds a known signal bandwidths.

28. The wire-line signal analyzer of claim 19, wherein the processor is configured with processor-executable instructions to characterize the received RF signal based on the one or more signal characteristics by determining whether a date and time of reception of the received RF signal matches a signal broadcast schedule.

29. A non-transitory processor-readable storage medium having stored thereon processor-executable instructions configured to cause a processor of a wire-line signal analyzer to perform operations for transmit power management in a wire-line communication system, the operations comprising:
determining one or more signal characteristics of a radio frequency (RF) signal received by the wire-line communication system;
characterizing the received RF signal based on the one or more signal characteristics;
determining whether the received RF signal is a valid signal based on the characterization of the received signal; and
determining a transmit power for a signal from the wire-line communication system based on the characterization of the received RF signal when the received RF signal is a valid signal.

30. A wire-line signal analyzer wire-line communication system, comprising:
means for determining one or more signal characteristics of a radio frequency (RF) signal received by the wire-line communication system;
means for characterizing the received RF signal based on the one or more signal characteristics;
means for determining whether the received RF signal is a valid signal based on the characterization of the received signal; and
means for determining a transmit power for a signal from the wire-line communication system based on the characterization of the received RF signal when the received RF signal is a valid signal.
